(19) United States
(12) Patent Application Publication
(10) Pub. No.: US 2016/0160929 A1
(43) Pub. Date: Jun. 9, 2016

(54) Mechanical coupling device for securing drive components

(71) Applicant: Vladmir Jose Janatka, Woodbury, CT (US)

(72) Inventor: Vladmir Jose Janatka, Woodbury, CT (US)

(21) Appl. No.: 14/121,792

(22) Filed: Dec. 9, 2014

(51) Int. Cl. F16D 1/08

(52) U.S. Cl. CPC F16D 1/0864

(57) ABSTRACT

A device for securing a driven component to a drive shaft features an abutment surface engageable with a drive member in flat surface-to-surface engagement for aligning the drive member mounted on the coupling device, in precise alignment with both the coupling device and a rotatable drive transmission shaft to which the coupling device is fixed. The hub having an extended slotted member and a hub member, where the hub member has a knurled surface for securing the hub to the drive component by pressed fit. A clamp collar is used for clamping the slotted member to the drive shaft. The hub member also has raised annular lip to secure the clamp collar. The extended slotted member further includes a unitarily formed flange with a detent nib for anti rotation of the clamp collar.

### FIELD OF THE INVENTION

This invention relates to machines having rotating mechanical drive components and more particularly where the rotary components are subject to high levels of stop and go operation as well as load deviations.

### BACKGROUND ART

In machines having mechanical drive components, a multiplicity of hubs may be required which are subject to stop-start/back and forth movements typically caused by clutch and brake operations and impart continuing fluctuations in load, due to rapid acceleration and deceleration movements of mechanical drives. These mechanical drive components such as pulleys, gears, sprockets, cams and rollers and the like, frequently become loosened from their hub on the drive shaft. An example of a device for securing a drive member to a shaft, is set forth in U.S. Pat. No. 5,052,842 wherein a discrete hub having a split end portion is used in conjunction with a commercially available split clamp collar to assemble a drive member on a shaft subject to high rates of stop and go operations. The hub has a knurled portion which is secured in a center hole of the mechanical drive member, and the split clamp collar is installed over the split end portion of the hub.

A problem with the prior background art, is that the split clamp collar may be inadvertently assembled 180 degrees off. The disadvantage here, is that as the clamp collar is tightened, the alignment rib may not be in proper position and a split clamp collar could tighten on the alignment rib itself as shown on FIG. 2, This will limit a spit collar's capabilities to achieve optimum clamping ability for which it was designed. It is for this reason that individual assemblers need to pay special attention in order to insure that the alignment rib is correctly located.

Furthermore, since there is no features that quickly secure the collar onto the hub, this assembly does not lend itself to be stored or stocked with the hub and collar as one.

An additional disadvantage of existing hubs, is that the clamp collar may shift axially from the hub during tightening see FIG. 1. Since there are no means to secure the collar axially. Individuals who assemble mechanical assemblies at times, find that they have to use tools with long handles or features that allow them to reach extended distances, since the drive components that need to be tightened, may be located deep in the final product assembly. While doing so, the collar may shift axially on the hub and in some instances become completely dislocated from the hub itself as its being tightened. This is particularly common while assembling deep in the product assemblies, where there are poor lighting conditions.

An objective to the claimed invention is to provides such an improved coupling device where the clamp collar will snap into location not allowing the clamp collar to shift on the hub or become dislocated when installed, and will not limit the clamp collar's capability to achieve optimum clamping strength.

Furthermore, since there is no features that quickly secure the clamp collar onto the hub, this assembly does not lend itself to be stored or stocked as one.

### BRIEF SUMMARY OF THE INVENTION

The intent of this unique invention is to provide an improved coupling device for securing a mechanical drive member to a rotatable shaft and which automatically aligns the shaft and the drive member in coaxial alignment with one another and with the coupling device itself upon assembly.

An objective of this invention is to provide such an improved coupling device which not only is easier to install, but will not allow the clamp collar to shift axially on the hub upon being tightened on to the shaft during assembly.

Additionally, due to a design feature, the hub and collar can be preassembled and stocked as one. Also eliminating the need to match hub size to the correct collar size, at the time of the product assembly.

Finally, an additional feature provides a means of deterring the collar from rotating relative to the hub while tightening of the collar. This feature can not hinder or interfere with the clamp's ability to tightened appropriately:

### BRIEF DESCRIPTION OF THE DRAWINGS

FIG. 1. Is a section view taken generally along line 1-1 of FIG. 2 showing prior art device and clamp collar assembly.

FIG. 2. Is an end view of the prior art device of FIG. 1;

FIG. 2A. Is an enlarged view of a portion of FIG. 2;

FIG. 3. Shows a side view of the device embodying the present invention;

FIG. 4. Is a section view taken generally along line 4-4 of FIG. 5;

FIG. 5. Is an end view of the device of FIG. 3;

FIG. 6. Is an isometric view of the device of FIG. 3;

FIG. 6A. Is an enlarged view of a portion of FIG. 6;

FIG. 7. Illustrates an end view of device of FIG. 8, showing a clamp collar assembled thereon;

FIG. 7A. Is an enlarged view of a portion of FIG. 7;

FIG. 8. Is a section view taken generally along line 8-8 of FIG. 7;

FIG. 9. Is an exploded isometric view of the device of FIG. 3, in a typical assembly with a drive member to which the device is to be secured to, a drive shaft for rotating the drive member and a clamp collar for securing the device to the shaft.

FIG. 10. Shows an isometric view of an assembled FIG. 9

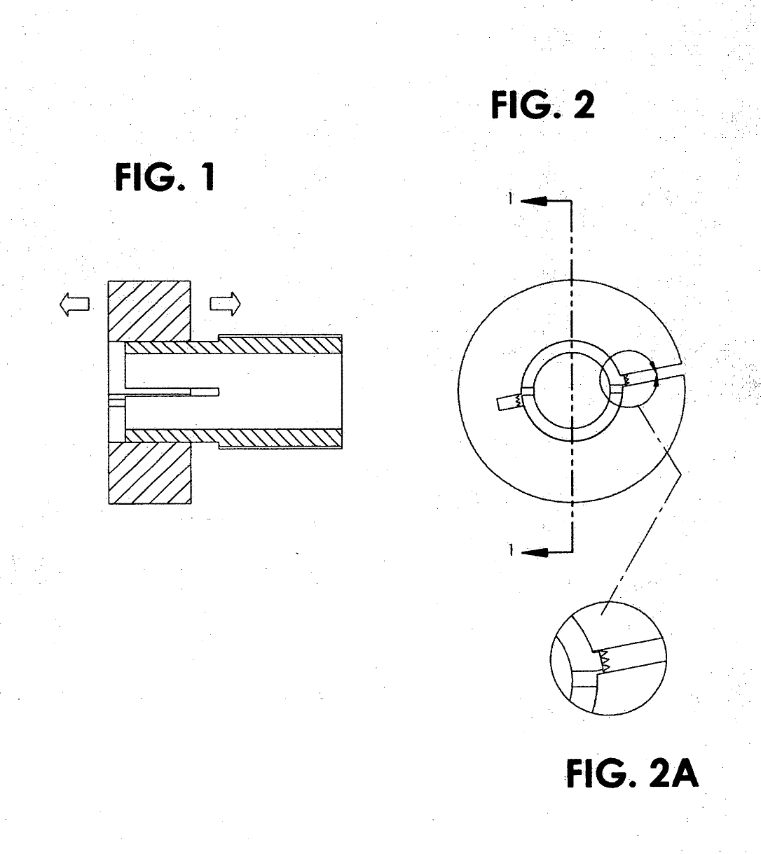

### DETAILED DESCRIPTION AND BEST MODE OF IMPLEMENTATION

The preferred material for the collar and the hub is steel, but may be replaced with stainless steel, copper, brass, powdered metal or plastics.

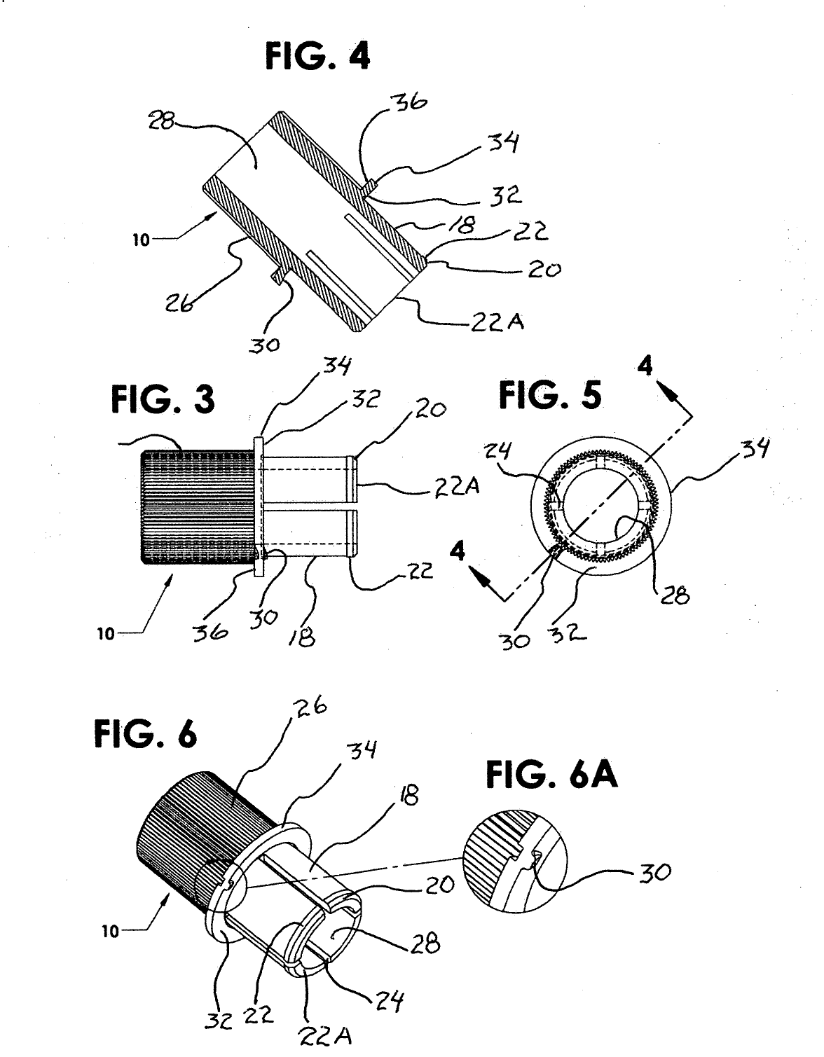

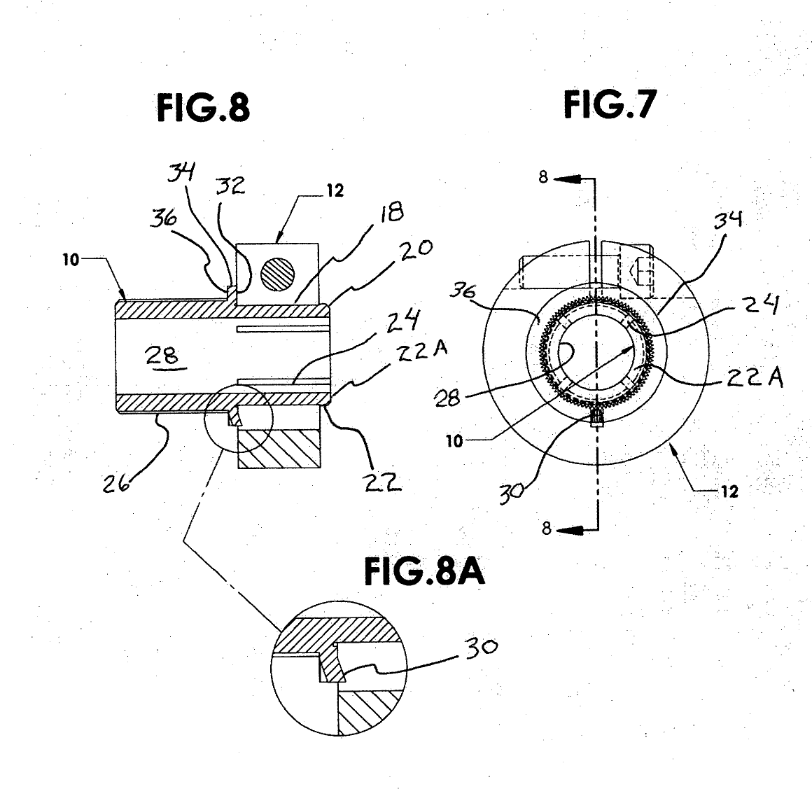

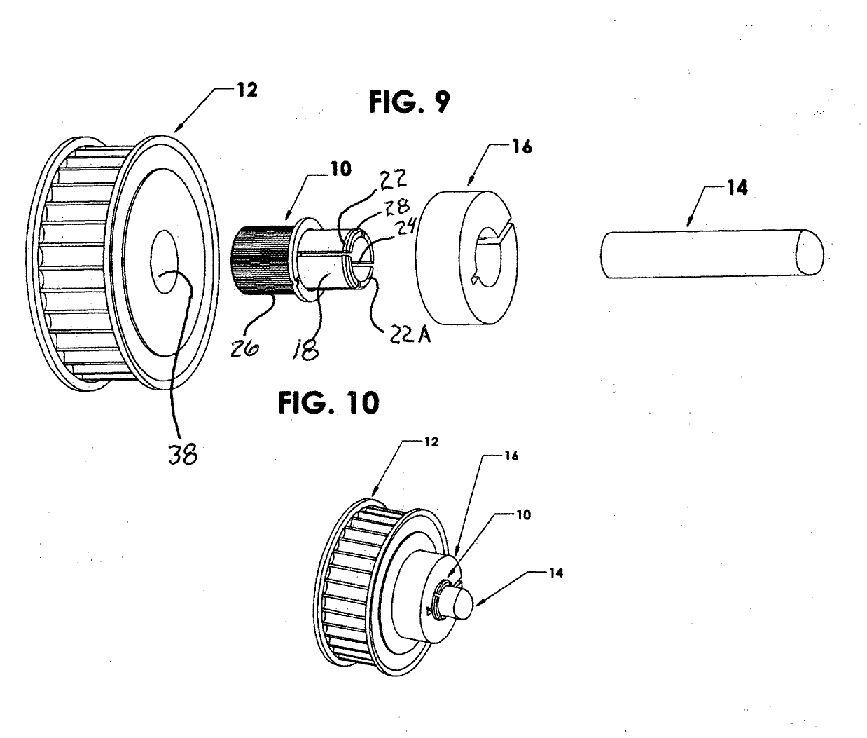

Referring now to the drawings in detail, and in particular FIG. 3 thru FIG. 10. To secure the clamping device 10 and the drive member 12 to the drive shaft 14, a split clamping collar such as 16 is mounted on clamping end portion 18, as shown in FIG. 9 and FIG. 10. Axial shifting of the clamping collar 16 during its assembly on the clamping device 10 is prevented by the provision of a raised annular detent lip 22 formed on a terminal end 22A of clamping end portion 18 of the clamping device 10, seen on FIG. 3. To permit inward deflection of the clamping end portion 18 of the clamping device 10, so that the clamping collar 16, may be allowed to slip over the detent lip 22. Four equiangular spaced slots such as at 24, seen in FIG. 5, are preferably formed to extend longitudinally inward from the terminal end 22A towards the knurled hub portion 26. In addition, mounting of the collar 16 on the clamping end portion 18 of the hub 10 is further facilitated by an annular lead in chamfer 28 formed on a detent lip 22. As will be appreciated by those skilled in the art, the four equally spaced segments, that make up the clamping portion 18 of the coupling device 10, thus allow for these segments and the detent lips 22 to be deflected radially inward as the collar 16 is slipped over these detent lips 22 before the shaft 14 is inserted though the center opening 28 of the clamping device 10. Once this condition is met, the four equally spaced segments that make up the clamping end portion 18, are unable to deflect inward, due to the shaft placement, and therefore the collar is unable to shift axially relative to the clamping device, seen in FIG. 9 and FIG. 10

To further ease assembly and to prevent the collar 16 from rotating upon the end portion 18 during such assembly, an anti-rotation detent nib 30 is provided on face 32 of the flange, as best seen in FIG. 6A. The detent nib 30 is located adjacent at the peripheral edge of flange 34 and registers with one of slots in the split collar 16. The hub 10 is clamped on the shaft 14 by tightening the screw on collar 16. The detent nib 30 prevents the assembler from chasing the collar's tightening screw. Since this detent nib 30 is only indented as a “detent” and does not run the entire length of clamping portion of the hub, therefore it will not interfere with the clamp collar's tightening design intent and capabilities. See FIG. 6

By virtue of such one-piece construction, possibility of error being introduced during each of the normally encountered multiple assembly steps, conventionally required by the prior art is entirely eliminated while providing a significantly more durable product which is believed to minimize failures encountered in more common designs of the known art. To provide an interference or pressed fit with a drive member 12, the hub 10 is shown as being of reduced size relative to the clamping collar 16 and having a knurled outer surface 26 extending coaxially from the collar 16 for affixing the device 10 to a drive member 12 by an interference or press fit within its central opening 38. see FIG. 9

By virtue of the above described construction, the coupling

device 10 of this invention will be seen to be quick and easy to install while automatically eliminating problems in potential misalignment among the axes of the shaft 14, the drive member 12 and the coupling device 10. Moreover, there are no requirements for passing a retaining pin or screw, e.g., through an opening in an outer periphery of the coupling device 10, collar 16 or the drive member 12. Rather, the construction of the described preferred embodiments provides for an outer surface on the shaft 14 and the drive member 12 to remain desirably uninterrupted.

Although this invention has been illustrated and described with respect to exemplary embodiments thereof, it should be understood by those skilled in the art that various changes, omissions and additions maybe made without departing from the spirit and scope of the invention.

A coupling device 10 for mounting a drive member 12 on a rotatable shaft 14 and automatically aligning the shaft 14 with the drive member 12 and the coupling device 10 in coaxial alignment with one another upon assembly. The coupling device 10 comprising a one-piece generally tubular body having a shaft-receiving through opening 28, a clamping end portion 18 and an opposite end portion 26, the opposite end portion 26 having an outer surface defining a drive member-supporting hub 26, the body including an abutment surface 36 extending radially, outwardly relative to the coupling device 10 for serving as a drive member 12 engaging stop for the coupling device. See FIG. 3

The device of claim 1 wherein the clamping end portion 18 includes a terminal end 22A and four equiangularly spaced slots 24 extending longitudinally from the terminal end 22A of the clamping end 18 portion toward the abutment surface 32, and wherein a clamping collar detent lip is formed on the terminal end 22. see FIG. 3 thru FIG. 6

1. A coupling device for mounting a drive member on a rotatable shaft and automatically aligning the shaft, the drive member and the coupling device in coaxial alignment with one another upon assembly, the coupling device comprising a one-piece generally tubular body having a shaft-receiving through opening, a clamping end portion and an opposite end portion, the opposite end portion having an outer surface defining a drive member-supporting hub, the body including an abutment surface formed as an integral part of the body, the abutment surface extending radially, outwardly relative to the hub for serving as a drive member-engaging stop for the coupling device.

2. The device of claim 1 wherein the hub has a knurled outer surface, and wherein the hub is of a predetermined axial length and coacts with an abutment surface for limiting drive member insertion of the hub.

3. The device of claim 1 wherein the clamping end portion includes a terminal end and four equiangularly spaced slots that also make up four equiangularly spaced segments.

4. The assembly of claim 1 wherein the outer surface of the hub is knurled, wherein the clamping end portion of the coupling device body includes a terminal end and spaced slots extending longitudinally from the terminal end of the clamping end portion toward the flange, wherein the clamping end portion has a detent lip formed on its terminal end with an annular lead-in chamfer formed on the detent lip, and wherein a clamping collar is snap-fit over the detent lip onto the clamping end portion, the clamping collar being restrained between the detent lip and the flange against undesired axial movement on the clamping end portion of the coupling device body during assembly.

5. The features of claim 3 allow for reduced cross sectional beam strength, along the clamping portion of the hub, and will result in more uniform clamping forces.

6. The device of claim 4 wherein a clamping collar is snap-fit over the detent lip onto the clamping end portion, the clamping collar being restrained between the detent lip and the flange in order to facilitate handling and storage by keeping this assembly as one prior to assembly and during installation.
